(19) United States
(12) Patent Application Publication
(10) Pub. No.: US 2005/0214619 A1
(43) Pub. Date: Sep. 29, 2005

(54) Fuel cell stack

(76) Inventors: So Fujiwara, Yaita-shi (JP); Yuya Sato, Saitama-shi (JP); Ken Takahashi, Tochigi-ken (JP); Ichiro Baba, Utsunomiya-shi (JP); Daisuke Wachi, Shioya-gun (JP)

Correspondence Address: FISH & RICHARDSON P.C., CITIGROUP CENTER 52ND FLOOR, 153 EAST 53RD STREET, NEW YORK, NY, 10022-4611, US

(21) Appl. No.: 11/091,536

(22) Filed: Mar. 28, 2005

(30) Foreign Application Priority Data
Mar. 29, 2004 (JP) NO. 2004-094369

(51) Int. Cl. H01M 8/02

(52) U.S. Cl. 429/34

(57) ABSTRACT

A fuel cell stack includes a plurality of unit cells each including a membrane electrode assembly and first and second metal separators sandwiching the membrane electrode assembly. The unit cells are stacked into a stack body, and the stack body is placed in a casing. Fluorocarbon resin sheets are provided between four sides of the stack body in parallel with the stacking direction of the stacked body and side plates of the casing, respectively. The fluorocarbon resin sheets fill gaps between stack body and inner surfaces of the casing.

### BACKGROUND OF THE INVENTION

1. Field of the Invention

The present invention relates to a fuel cell stack including a box-shaped casing and a stack body in the casing. The stack body is formed by stacking a plurality of unit cells. Each of the unit cells includes an electrolyte electrode assembly and metal separators sandwiching the electrolyte electrode assembly. The electrolyte electrode assembly includes a pair of electrodes, and an electrolyte interposed between the electrodes. The metal separator includes a metal plate and a cover member covering an outer end of the metal plate.

2. Description of the Related Art

For example, a solid polymer fuel cell employs a membrane electrode assembly which includes an anode and a cathode, and an electrolyte membrane (electrolyte) interposed between the anode and the cathode. The electrolyte membrane is a polymer ion exchange membrane. The membrane electrode assembly and separators sandwiching the membrane electrode assembly make up a unit of a fuel cell (unit cell) for generating electricity. Each of the anode and the cathode is made of electrode catalyst layer of noble metal formed on a base material chiefly containing carbon.

In the fuel cell, a fuel gas such as a gas chiefly containing hydrogen (hereinafter also referred to as the hydrogen-containing gas) is supplied to the anode. A gas chiefly containing oxygen or air (hereinafter also referred to as the oxygen-containing gas) is supplied to the cathode. The catalyst of the anode induces a chemical reaction of the fuel gas to split the hydrogen molecule into hydrogen ions and electrons. The hydrogen ions move toward the cathode through the electrolyte membrane, and the electrons flow through an external circuit to the cathode, creating a DC electrical energy.

Generally, a predetermined number of, e.g., several tens to several hundreds of fuel cells are stacked together to form a fuel cell stack for achieving the desired level of electricity in power generation. Components of the fuel cell stack need to be tightened together reliably without changing the orientation undesirably so that the internal resistance of the fuel cell does not increase, and the sealing performance for preventing leakage of reactant gases is maintained.

In this regard, for example, a fuel cell support device as disclosed in Japanese Laid-Open Patent Publication No. 2003-77501 is known. As shown in FIG. 5, the fuel cell support deice includes cell stack bodies 2. Each of the cell stack bodies 2 is formed by stacking a plurality of unit cells 1. The cell stack bodies 2 are arranged in four rows in a housing 3. The housing 3 includes walls 3a, 3b, 3c, 3d, and divider walls 3e. When the stacking direction of the cell stack bodies 2 is horizontal, the walls 3a, 3b are positioned at the top and bottom of the cell stack bodies 2, and the walls 3c, 3d are positioned on the left and right sides of the cell stack bodies 2, respectively. The divider walls 3e are integral with the walls 3a, 3b, and divides the cell stack bodies 2 from each other.

Tension members (metal members) 4 are embedded in each of the walls 3a, 3b. The tension members 4 are insulated from separators (not shown) by resin material as part of the walls 3a, 3b. Gas manifolds 5 are provided inside the walls 3a to 3d of the housing 3 at positions where the tension members 4 are not provided.

In this structure, the walls 3a to 3d, and the divider walls 3e of the housing 3 support an outer region of the cell stack bodies 2. Thus, according to the disclosure, it is possible to prevent deformation without changing the orientation of the cell stack bodies 2 undesirably.

Further, according to the disclosure, the tension members 4 are embedded in the walls 3a, 3b, respectively. The walls 3a, 3b are made of resin, and the tension members 4 are made of metal. Thus, the walls 3a, 3b can easily absorb shocks, and the tension members 4 can easily support the tightening load applied to the cell stack bodies 2.

Metal plates are suitable for fabricating thin and light separators. Therefore, the metal plates may be used as the separators for the unit cell 1. In this case, a cover member such as a rubber seal is provided on the outer region of the metal plate in order to maintain insulating and sealing performances.

However, if the metal separator is used in the conventional technique, a relatively large frictional resistance is generated between the cover member provided on the outer region of the metal separator and the inner surfaces of the walls 3a to 3d and the divider walls 3e.

Therefore, in particular, if the fuel cell is mounted on a vehicle, when an inertia force is applied to the stack bodies 2, sliding occurs in some parts between the outer region of the metal separator and the inner wall surfaces, while sliding does not occur in other parts. Thus, gaps are formed partially between the adjacent metal separators.

### SUMMARY OF THE INVENTION

A main object of the present invention is to provide a fuel cell stack in which a stack body formed by stacking unit cells is placed suitably in a casing, and sliding resistance between an outer region of the stack body and an inner surface of the casing is suitably reduced.

The present invention relates to a fuel cell stack comprising a box-shaped casing and a stack body provided in the casing. The stack body is formed by stacking a plurality of unit cells in a horizontal direction. Each of the unit cells includes an electrolyte electrode assembly and separators sandwiching the electrolyte electrode assembly. The electrolyte electrode assembly includes a pair of electrodes, and an electrolyte interposed between the electrodes. Each of the separators includes a plate and a cover member covering an outer end of the plate. The separators should preferably comprise metal plates.

The casing comprises end plates provided at opposite ends of the stack body in the stacking direction, a plurality of side plates provided on sides of the stack body. A sheet for reducing sliding resistance such as a fluorocarbon resin sheet is provided at least between one side of the stack body and an inner surface of the side plate for filling a gap between the stack body and an inner surface of the casing.

Further, it is preferable that the fluorocarbon resin sheet is placed in the casing, between at least one side as a bottom surface of the stack body and a bottom surface of the casing. Therefore, the bottom surface of the stack body is placed on the fluorocarbon resin sheet, and smoothly slides along the fluorocarbon resin sheet.

In the present invention, the sliding resistance (frictional resistance) between the sides of the stack body and the inner surfaces of the side plates is reduced greatly. Thus, the cover members covering the outer ends of the respective metal separators slide along the fluorocarbon resin sheets smoothly. Therefore, the metal separators are not spaced from each other excessively. Deformation of the metal separators is advantageously prevented as much as possible.

Further, the fluorocarbon resin sheets fill the gaps between the sides of the stack body and the inner surfaces of the side plates. Thus, the stack body is reliably supported without wobbling in the casing. Further, the fluorocarbon resin sheets are insulating sheets. Therefore, when the unit cells contact the fluorocarbon resin sheets, no short circuit occurs between unit cells.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view schematically showing part of a fuel cell stack according to an embodiment of the present invention;

FIG. 2 is a cross sectional side view showing part of the fuel cell stack;

FIG. 3 is an exploded perspective view showing a unit cell of the fuel cell stack;

FIG. 4 is a perspective view showing the fuel cell stack; and

FIG. 5 is a view schematically showing a conventional fuel cell.

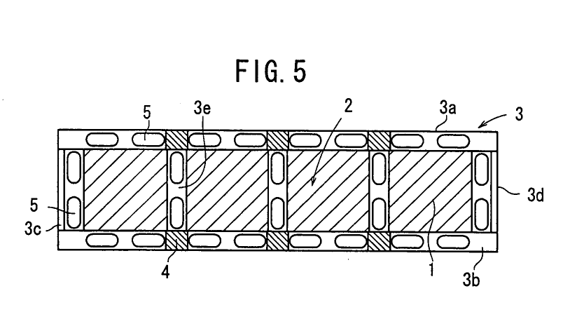

### DESCRIPTION OF THE PREFERRED EMBODIMENTS

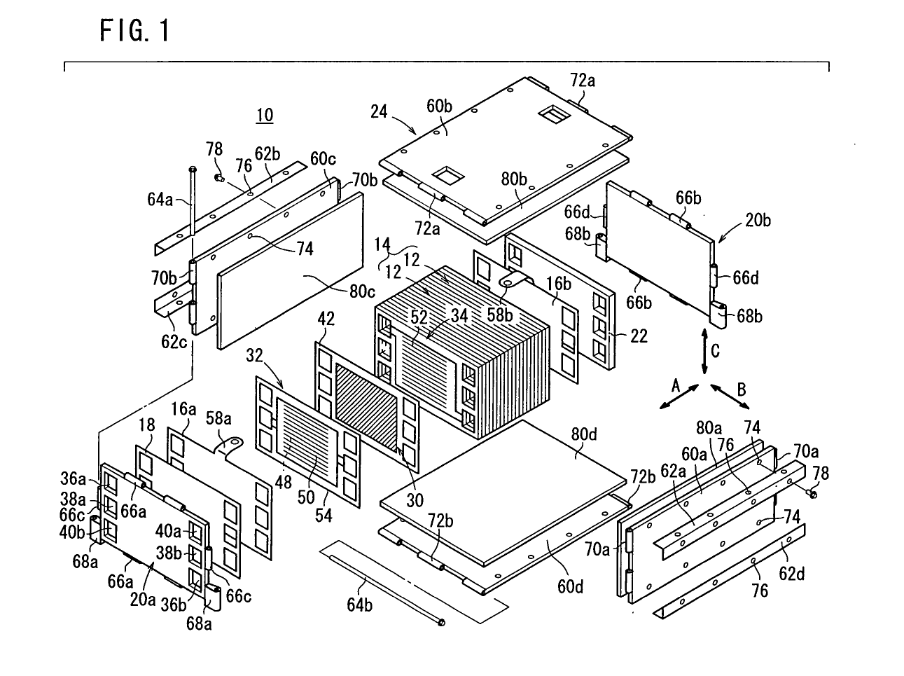

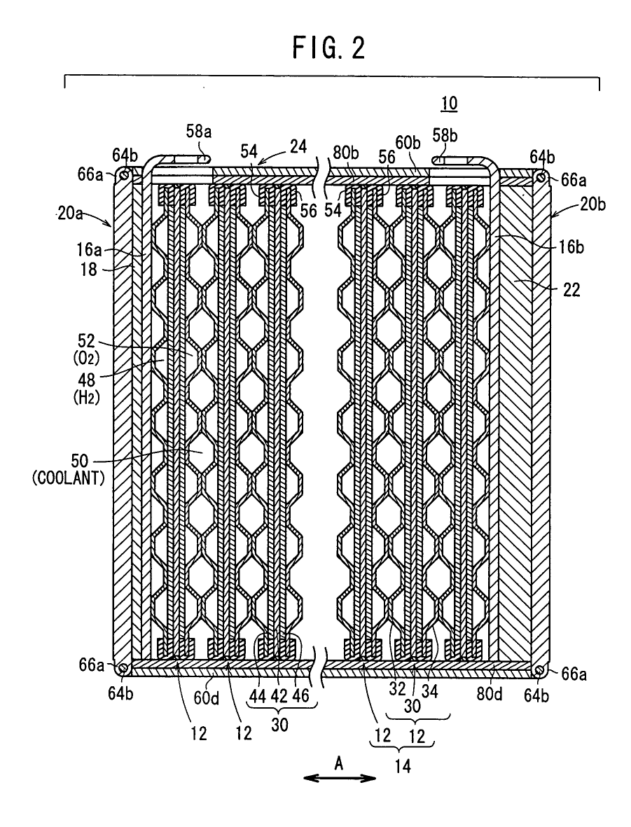

FIG. 1 is an exploded perspective view schematically showing part of a fuel cell stack 10 according to an embodiment of the present invention. FIG. 2 is a cross sectional side view showing part of the fuel cell stack 10.

As shown in FIG. 1, the fuel cell stack 10 includes a stack body 14 formed by stacking a plurality of unit cells 12 horizontally in a stacking direction indicated by an arrow A. At one end of the stack body 14 in the stacking direction indicated by the arrow A, a terminal plate 16a is provided. An insulating plate 18 is provided outside the terminal plate 16a. Further, an end plate 20a is provided outside the insulating plate 18. At the other end of the stack body 14 in the stacking direction, a terminal plate 16b is provided. An insulating spacer member 22 is provided outside the terminal plate 16b. Further, an end plate 20b is provided outside the insulating spacer member 22. Each of the end plates 20a, 20b has a rectangular shape. The fuel cell stack 10 is assembled together such that the stack body 14 formed by stacking the unit cells 12 is housed in a casing 24 including the end plates 20a, 20b.

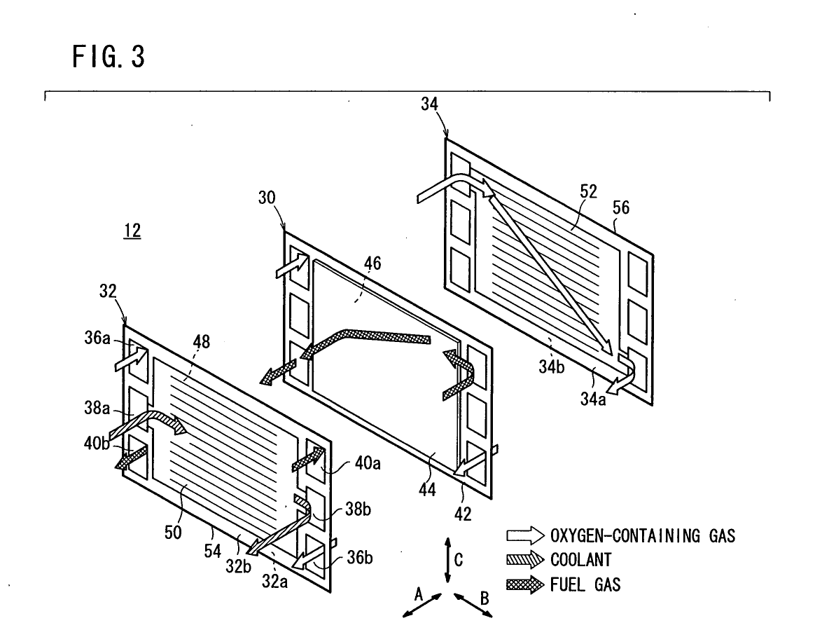

As shown in FIGS. 2 and 3, each of the unit cells 12 includes a membrane electrode assembly (electrolyte electrode assembly) 30 and thin corrugated plates as first and second metal separators 32, 34 sandwiching the membrane electrode assembly 30. The first and second metal separators 32, 34 are thin metal plates such as steel plates, stainless steel plates, aluminum plates, or plated steel sheets.

At one end of the unit cell 12 in a longitudinal direction indicated by an arrow B in FIG. 3, an oxygen-containing gas supply passage 36a for supplying an oxygen-containing gas, a coolant supply passage 38a for supplying a coolant, and a fuel gas discharge passage 40b for discharging a fuel gas such as a hydrogen-containing gas are provided. The oxygen-containing gas supply passage 36a, the coolant supply passage 38a, and the fuel gas discharge passage 40b extend through the unit cell 12 in the direction indicated by the arrow A.

At the other end of the unit cell 12 in the longitudinal direction, a fuel gas supply passage 40a for supplying the fuel gas, a coolant discharge passage 38b for discharging the coolant, and an oxygen-containing gas discharge passage 36b for discharging the oxygen-containing gas are provided. The fuel gas supply passage 40a, the coolant discharge passage 38b, and the oxygen-containing gas discharge passage 36b extend through the unit cell 12 in the direction indicated by the arrow A.

The membrane electrode assembly 30 includes an anode 44, a cathode 46, and a solid polymer electrolyte membrane 42 interposed between the anode 44 and the cathode 46. The solid polymer electrolyte membrane 42 is formed by impregnating a thin membrane of perfluorosulfonic acid with water, for example. Each of the anode 44 and the cathode 46 has a gas diffusion layer (not shown) such as a carbon paper, and an electrode catalyst layer (not shown) of platinum alloy supported on porous carbon particles. The carbon particles are deposited uniformly on the surface of the gas diffusion layer. The electrode catalyst layer of the anode 44 and the electrode catalyst layer of the cathode 46 are fixed to both surfaces of the solid polymer electrolyte membrane 42, respectively.

The first metal separator 32 has a fuel gas flow field 48 on its surface 32a facing the membrane electrode assembly 30. The fuel gas flow field 48 is connected to the fuel gas supply passage 40a at one end, and connected to the fuel gas discharge passage 40b at the other end. The fuel gas flow field 48 includes a plurality of grooves extending in the direction indicated by the arrow B, for example. Further, the first metal separator 32 has a coolant flow field 50 on the other surface 32b. The coolant flow field 50 is connected to the coolant supply passage 38a at one end, and connected to the coolant discharge passage 38b at the other end. The coolant flow field 50 includes a plurality of grooves extending in the direction indicated by the arrow B.

The second metal separator 34 has an oxygen-containing gas flow field 52 on its surface 34a facing the membrane electrode assembly 30. The oxygen-containing gas flow field 52 is connected to the oxygen-containing gas supply passage 36a at one end, and connected to the oxygen-containing gas discharge passage 36b at the other end. The oxygen-containing gas flow field 52 includes a plurality of grooves extending in the direction indicated by the arrow B. The other surface 34b of the second metal separator 34 is stacked on the surface 32b of the first metal separator 32. When the first metal separator 32 and the second metal separator 34 are stacked together, the coolant flow field 50 is formed between the surface 32b of the first metal separator 32 and the surface 34b of the second metal separator 34.

A first seal member (cover member) 54 is formed integrally on the surfaces 32a, 32b of the first metal separator 32 around the outer end of the first metal separator 32. The first seal member 54 is made of seal material, cushion material or packing material such as EPDM (Ethylene Propylene Diene Monomer), NBR (Nitrile Butadiene Rubber), fluorocarbon rubber, silicone rubber, fluoro silicone rubber, butyl rubber (Isobutene-Isoprene Rubber), natural rubber, styrene rubber, chloroprene rubber, or acrylic rubber.

On the surface 32a, the first seal member 54 is formed around the fuel gas supply passage 40a, the fuel gas discharge passage 40b, and the fuel gas flow field 48, and prevents leakage of the fuel gas which flows between the fuel gas supply passage 40a and the fuel gas flow field 48, and between the fuel gas flow field 48 and the fuel gas discharge passage 40b. Further, on the surface 32b, the first seal member 54 is formed around the coolant supply passage 38a, the coolant discharge passage 38b, and the coolant flow field 50, and prevents leakage of the coolant which flows between the coolant supply passage 38a and the coolant flow field 50, and between the coolant flow field 50 and the coolant discharge passage 38b.

As with the first metal separator 32, a second seal member (cover member) 56 is formed integrally on the surfaces 34a, 34b of the second metal separator 34 around the outer end of the second metal separator 34. On the surface 34a, the second seal member 56 is formed around the oxygen-containing gas supply passage 36a, the oxygen-containing gas discharge passage 36b, and the oxygen-containing gas flow field 52, and prevents leakage of the oxygen-containing gas which flows between the oxygen-containing gas supply passage 36a and the oxygen-containing gas flow field 52, and between the oxygen-containing gas flow field 52 and the oxygen-containing gas discharge passage 36b. Further, on the surface 34b, the second seal member 56 is formed around the coolant supply passage 38a, the coolant discharge passage 38b, and the coolant flow field 50, and prevents leakage of the coolant which flows between the coolant supply passage 38a and the coolant flow field 50, and between the coolant flow field 50 and the coolant discharge passage 38b.

As shown in FIGS. 1 and 2, plate-shaped terminals 58a, 58b extend from the terminal plates 16a, 16b, respectively. The terminals 58a, 58b are connected to a load such as a motor of a vehicle.

As shown in FIG. 1, the casing 24 includes the end plates 20a, 20b, a plurality of side plates 60a to 60d, angle members (e.g., L angles) 62a to 62d, and coupling pins 64a, 64b. The side plates 60a to 60d are provided on sides of the stack body 14. The angle members 62a to 62d are used for coupling adjacent ends of the side plates 60a to 60d. The coupling pins 64a, 64b are used for coupling the end plates 20a, 20b and the side plates 60a to 60d. The length of the coupling pins 64a is small in comparison with the length of the coupling pins 64b.

Each of upper and lower ends of the end plate 20a has two first coupling portions 66a. Each of upper and lower ends of the end plate 20b has two first coupling portions 66b. Each of left and right ends of the end plate 20a has one first coupling portion 66c. Each of left and right ends of the end plate 20b has one first coupling portion 66d. The end plate 20a has mounting bosses 68a on its left and right lower ends. The end plate 20b has mounting bosses 68b on its left and right lower ends. The bosses 68a, 68b are fixed to mounting positions (not shown) using bolts or the like for installing the fuel cell stack 10 in a vehicle, for example.

The side plates 60a, 60c are provided on opposite lateral sides of the stack body 14. Each of longitudinal ends of the side plate 60a has two second coupling portions 70a. Each of longitudinal ends of the side plate 60b has two second coupling portions 70b. The side plate 60b is provided on the upper side of the stack body 14, and the side plate 60d is provided on the lower side of the stack body 14. Each of longitudinal ends of the side plate 60b has three second coupling portions 72a. Each of longitudinal ends of the side plate 60d has three second coupling portions 72b.

In assembling the end plates 20a, 20b and the side plates 60a to 60d, the first coupling portions 66c of the end plate 20a, and the first coupling portions 66d of the end plate 20b are positioned between the second coupling portions 70a of the side plate 60a, and between the second coupling portions 70b of the side plate 60c. The short coupling pins 64a are inserted into these coupling portions 66c, 66d, 70a, 70b for coupling the side plates 60a, 60c, and the end plates 20a, 20b.

Likewise, the second coupling portions 72a of the side plate 60b and the first coupling portions 66a, 66b of the upper end of the end plates 20a, 20b are positioned alternately, and the second coupling portions 72b of the side plate 60d and the first coupling portions 66a, 66b of the lower end of the end plates 20a, 20b are positioned alternately. The long coupling pins 64b are inserted into these coupling portions 66a, 66b, 72a, 72b for coupling the side plates 60b, 60d and the end plates 20a, 20b.

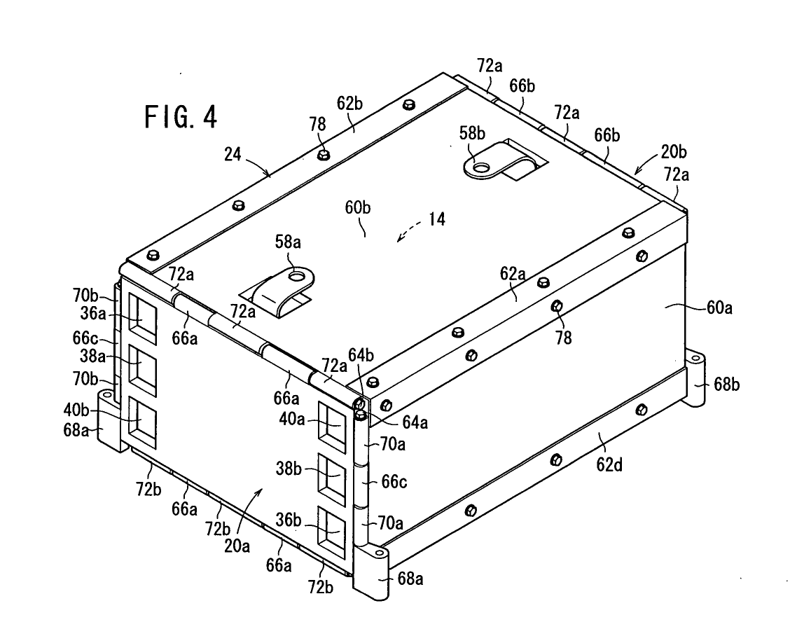

A plurality of screw holes 74 are formed along opposite edges of the side plates 60a to 60d. The screw holes 74 are arranged in the direction indicated by the arrow A. Further, screw holes 76 are provided along the lengths of the angle members 62a to 62d at positions corresponding to the screw holes 74. Screws 78 are inserted into the screw holes 76 and the screw holes 74 to fix the side plates 60a to 60d together using the angle members 62a to 62d. In this manner, the side plates 60a to 60d, and the end plates 20a, 20b are assembled into the casing 24 (see FIG. 4).

Alternatively, the angle members 62a to 62d may be placed inside the side plates 60a to 60d, and the screws are inserted into the screw holes of the angle members 62a to 62d and the side plates 60a to 60d to fix the angle members 62a to 62d and the side plates 60a to 60d together.

As shown in FIGS. 1 and 2, the insulating spacer member 22 has a rectangular shape having predetermined dimensions such that the insulating spacer member 22 is positioned inside the casing 24. The thickness of the insulating spacer member 22 is selected such that the dimensional variation in the stacking direction of the stack body 14 is absorbed, and the desired tightening force is applied to the stack body 14.

As shown in FIG. 1, fluorocarbon resin sheets 80a to 80d are provided between four sides of the stack body 14 in parallel with the stacking direction indicated by the arrow A and the side plates 60a to 60d, respectively. The fluorocarbon resin sheets 80a to 80d function to fill gaps between the stack body 14 and the inner surfaces of the casing 24. The thicknesses of the fluorocarbon resin sheets 80a to 80d are determined based on the gaps between the stack body 14 and the inner surfaces of the casing 24. For example, the fluorocarbon resin sheets 80a to 80d are adhered to the inner surfaces of the side plates 60a to 60d in advance.

In the fuel cell stack 10, as shown in FIG. 4, an oxygen-containing gas is supplied to the oxygen-containing gas supply passage 36a from the end plate 20a of the fuel cell stack 10. A fuel gas such as a hydrogen-containing gas is supplied to the fuel gas supply passage 40a. Further, a coolant such as pure water or an ethylene glycol is supplied to the coolant supply passage 38a. Thus, the oxygen-containing gas, the fuel gas, and the coolant are supplied to each of the unit cells 12 stacked together in the direction indicated by the arrow A to form the stack body 14. The oxygen-containing gas, the fuel gas, and the coolant flow in the direction indicated by the arrow A.

As shown in FIG. 3, the oxygen-containing gas flows from the oxygen-containing gas supply passage 36a into the oxygen-containing gas flow field 52 of the second metal separator 34. The oxygen-containing gas flows along the cathode 46 of the membrane electrode assembly 30. The fuel gas flows from the fuel gas supply passage 40a into the fuel gas flow field 48 of the first metal separator 32.

Thus, in each of the membrane electrode assemblies 30, the oxygen-containing gas supplied to the cathode 46, and the fuel gas supplied to the anode 44 are consumed in the electrochemical reactions at catalyst layers of the cathode 46 and the anode 44 for generating electricity.

After the oxygen in the oxygen-containing gas is consumed at the cathode 46, the oxygen-containing gas flows into the oxygen-containing gas discharge passage 36b, and is discharged to the outside from the end plate 20a. Likewise, after the fuel gas is consumed at the anode 44, the fuel gas flows into the fuel gas discharge passage 40b, and is discharged to the outside from the end plate 20a.

The coolant flows from the coolant supply passage 38a into the coolant flow field 50 between the first and second metal separators 32, 34, and flows in the direction indicated by the arrow B. After the coolant is used for cooling the membrane electrode assembly 30, the coolant flows into the coolant discharge passage 38b, and is discharged to the outside from the end plate 20a.

In the embodiment of the present invention, the fluorocarbon resin sheets 80a to 80d are provided between the sides of the stack body 14 and the side plates 60a to 60d of the casing 24. Therefore, when the first and second seal members 54, 56 are formed integrally around the outer ends of the first and second metal separators 32, 34 of each of the unit cells 12 of the stack body 14, the first and second seal members 54, 56 directly contact the inner surfaces of the fluorocarbon resin sheets 80a to 80d.

Thus, the sliding resistance (frictional resistance) between the sides of the stack body 14 and the fluorocarbon resin sheets 80a to 80d is significantly small in comparison with the case in which the sides of the stack body 14 contact the side plates 60a to 60d. Thus, the first and second seal members 54, 56 of each of the unit cells 12 of the stack body 14 slide along the fluorocarbon resin sheets 80a to 80d smoothly. Therefore, for example, the first and second metal separators 32, 34 are not spaced from each other excessively.

Thus, in the embodiment of the present invention, deformation of the first and second metal separators 32, 34 is advantageously prevented as much as possible.

Further, the fluorocarbon resin sheets 80a to 80d fill the gaps between the sides of the stack body 14 and the inner surfaces of the side plates 60a to 60d. Thus, the stack body 14 is reliably supported without wobbling in the casing 24. For example, even if an inertia force is applied to the fuel cell stack 10 mounted in a vehicle, the stack body 14 does not move undesirably.

Further, the fluorocarbon resin sheets 80a to 80d are insulating sheets. Therefore, when the unit cells 12 contact the fluorocarbon resin sheets 80a to 80d, no short circuit occurs between unit cells 12.

In the embodiment of the present invention, the fluorocarbon resin sheets 80a to 80d corresponding to the four sides of the stack body 14 are provided. Alternatively, only the fluorocarbon resin sheet 80d corresponding to one side of the stack body 14 which is the bottom surface of the stack body 14 may be provided. In this case, the stack body 14 is placed on the fluorocarbon resin sheet 80d, and smoothly slides on the fluorocarbon resin sheet 80d.

While the invention has been particularly shown and described with reference to a preferred embodiment, it will be understood that variations and modifications can be effected thereto by those skilled in the art without departing from the spirit and scope of the invention as defined by the appended claims.

1. A fuel cell stack comprising:
a box-shaped casing; and
a stack body provided in said casing, said stack body being formed by stacking a plurality of unit cells in a horizontal direction, said unit cells each including an electrolyte electrode assembly and separators sandwiching said electrolyte electrode assembly, said electrolyte electrode assembly including a pair of electrodes, and an electrolyte interposed between said electrodes, said separators each including a plate and a cover member covering an outer end of said plate, wherein said casing comprises:
end plates provided at opposite ends of said stack body in the stacking direction; and
a plurality of side plates provided on sides of said stack body, and wherein
a sheet for reducing sliding resistance is provided at least between one side of said stack body and an inner surface of said side plate for filling a gap between said stack body and an inner surface of said casing.

2. A fuel cell stack according to claim 1, wherein said separators comprise metal plates.

3. A fuel cell stack according to claim 1, wherein said sheet for reducing sliding resistance is placed in said casing, between at least one side as a bottom surface of said stack body and a bottom surface of said casing.

4. A fuel cell stack according to claim 1, wherein said sheet for reducing sliding resistance is an insulating sheet.

5. A fuel cell stack according to claim 1, wherein said sheet for reducing sliding distance is a fluorocarbon resin sheet.

6. A fuel cell stack according to claim 1, wherein said casing further comprises:
an angle member for coupling adjacent ends of said side plates; and
a coupling pin for coupling said end plate and said side plate.
